(19) United States
(12) Patent Application Publication
(10) Pub. No.: US 2004/0147425 A1
(43) Pub. Date: Jul. 29, 2004

(54) Wiping articles and their use

(75) Inventors: Artemio Castro, West Chester, OH (US); Edward Paul Fitch, Cincinnati, OH (US); Peter Robert Foley, Cincinnati, OH (US); Francis Cornelio Ford, Cincinnati, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/705,567

(22) Filed: Nov. 10, 2003

Related U.S. Application Data
(60) Provisional application No. 60/426,186, filed on Nov. 14, 2002.
(60) Provisional application No. 60/491,720, filed on Aug. 1, 2003.

(51) Int. Cl. C11D 17/00

(52) U.S. Cl. 510/438; 510/475

(57) ABSTRACT

Wipes impregnated with a cleaning composition particularly suitable for hand dishwashing are disclosed. A wipe is provided which is formed of a water-insoluble substrate having a cleaning composition applied thereto. The cleaning composition contains:

(a) surfactant; (b) a water-soluble thickening polymer having anionic side chains, such as polysaccharide or polysaccharide derivative, xanthan gum or a derivative thereof; and (c) a water-transfer agent capable of withdrawing water from the surfactant, such as silica, or more particularly fumed silica.

### CROSS REFERENCE TO RELATED APPLICATIONS

This application claims the benefit of U.S. Provisional Application No. 60/426,186, filed Nov. 14, 2002, and U.S. Provisional Application No. 60/491,720, filed Aug. 1, 2003, which are incorporated by reference herein.

### FIELD OF THE INVENTION

This invention relates to wipes suitable for use in cleaning surfaces, especially hand dishwashing. In particular the invention relates to articles impregnated with a cleaning composition suitable for hand dishwashing.

### BACKGROUND OF THE INVENTION

Wipes suitable for cleaning, especially hand dishwashing and hard surface cleaning, in which the article is impregnated with surfactant have been known for some time. Such articles are desirable as they are convenient for consumers, removing the need for separate storage of cleaning implements and cleaning compositions, and being quick and easy to use. For example, EP 211 664 discloses an article for cleaning in which the surfactant is entrapped in a polymer and impregnated into a sheet-like article. U.S. Pat. No. 4,515,703 discloses an article for wiping comprising two layers forming a closed sandwich structure with compartments for the active material.

Although wipes impregnated with surfactant are known, so far these have tended to release the active surfactant material undesirably quickly, leading to unsatisfactory cleaning properties. When the surfactant dissolves very quickly, a high suds level is obtained on initial use of the wipe, but within a short period the supply of surfactant is exhausted. This release profile results in an excess of suds at the start of the wash. Although consumers perceive high suds level as generally beneficial, the presence of excess suds makes rinsing items difficult. Furthermore, poor cleaning properties are obtained at the end of the wash due to surfactant only being available for a short time.

Attempts to overcome these problems have been made. For example EP 161 911 discloses a wipe for cleaning hard surfaces in which the release of the detergent is controlled by a moisture barrier comprising a hydrophobic material such as wax. This however requires a separate application step in order to apply the hydrophobic material to the wipe in addition to the surfactant-containing cleaning composition.

In our earlier publication WO 02/41748 we describe dishwashing wipes impregnated with dishwashing composition. This publication suggests the use of hydroxypropylmethyl cellulose HMPC, which is an essentially neutral polymer, as thickening agent to control release of the composition from the wipe. There is also a separate suggestion of use of porous hydrophobic silica in admixture with ingredients such as enzyme and other delicate ingredients as a carrier for addition of these materials to the composition. Hydrophobic silica can adsorb hydrophobic materials.

It would be desirable to provide a wipe suitable for hard surface cleaning and especially hand dishwashing in which is impregnated a cleaning composition and in which the cleaning composition is released over a controlled period of time.

### SUMMARY OF THE INVENTION

It has now been found that by incorporating a novel controlled release system for surfactant into cleaning wipes it is possible to increase the lifetime of the surfactant system and to obtain improved cleaning properties over a longer period of time.

Thus, according to a first aspect of the invention there is provided a wipe comprising a water-insoluble substrate having applied thereto a cleaning composition comprising:

(a) a surfactant,

(b) a water-soluble thickening polymer having anionic side chains and/or side chains which are anionic when in the cleaning composition itself, and

(c) a water-transfer agent capable of withdrawing water from the surfactant.

By combining the surfactant with the defined water-soluble thickening polymer and a water transfer agent capable of withdrawing water from the surfactant, it has been found that the surfactant is released more slowly from the wipe, overcoming the problems outlined above.

We believe that the inclusion of both water-soluble thickening polymer and water-transfer agent creates a structured environment that facilitates the rapid evaporation of water from the cleaning composition rendering it drier than cleaning compositions without water transfer agent and water soluble thickening polymer. This, we believe, contributes to control of release of the surfactant. Preferably the wipe of the invention is such that the cleaning composition has a level of free water not more than 15%, preferably not more than 10%. Free water can be measured as the percentage water, by weight of total composition, which can be readily lost by azeotropic distillation.

By choosing particular quantities of the water-soluble thickening polymer, it is possible to control the release profile of the surfactant according to particular needs. Preferably the composition applied to the substrate comprises from 2.5 to 15% of the water-soluble thickening polymer more preferably from 5 to 10% and even more preferably from 5 to 9% by weight of the composition. Most preferably the composition comprises about 7% of the water-soluble thickening polymer.

Therefore, according to a further aspect of the invention there is provided a wipe comprising a water-insoluble substrate having applied thereto a cleaning composition comprising:

(a) a surfactant, and

(b) 5 to 9 wt % water-soluble thickening polymer having anionic side chains and/or side chains which are anionic when in the cleaning composition itself.

Xanthan gum has been found to be a particularly useful water-soluble thickening polymer in the wipes of the invention. Therefore, according to a further aspect of the invention there is provided a wipe comprising a water-soluble substrate having applied thereto a cleaning composition comprising:

(a) a surfactant, and

(b) at least 3%, by weight of the composition applied to the substrate, xanthan gum or a derivative thereof.

### DETAILED DESCRIPTION OF THE PREFERRED EMBODIMENTS

Surfactant

Preferably, the surfactant used in the composition of the invention is selected from the group consisting of: anionic surfactants, amphoteric surfactants, nonionic surfactants, zwitterionic surfactants, and mixtures thereof. Preferably the composition comprises anionic surfactant. Preferred anionic surfactants include alkyl ethoxy sulfates. Preferred non-ionic surfactants include alcohol ethoxylates. Preferred amphoteric surfactants include amine oxides.

The surfactant may be combined with further ingredients to improve the cleaning properties. For example, (meth) acrylate polymers such as polydimethyl aminoethylmethacrylate may be used to improve suds character. Grease cleaning can be improved by the use of amines such as 1,3-cyclohexane bis(methylamine). Polyvalent cations such as Mg²⁺ are also useful for improving grease cleaning.

In a preferred embodiment of the invention the surfactant is applied to the substrate in the form of a concentrated surfactant paste. By “paste” it is meant that the material is in a solid state and does not continuously change its shape when subjected to a given yield stress. The cleaning paste flows under increased pressure and has a reduction in viscosity with increasing temperature.

Water-Soluble Thickening Polymer

The composition applied to the substrate comprises a water-soluble thickening polymer having anionic side chains and/or side chains which are anionic when in the cleaning composition itself. We believe that this polymer creates a three dimensional site on the water-insoluble substrate favourable for the aggregation of surfactant micelles. We believe that this polymer can also increase the interfacial solution viscosity of the surfactant-containing composition at the region of contact with water when the wipe is used, limiting water ingress to the surfactant when the wipe is contacted with wetted dishware. The release of surfactant from the wipe as the wipe is used can therefore be controlled.

The polymer has side chains which are anionic when in the cleaning composition itself, and preferably has a pKa in the range of 4 to 20.

Thus the side chains may be acid groups provided that the pKa of those acid groups is sufficiently low that under the pH conditions prevailing in the cleaning composition they are in the salt ? form. Generally acid groups having pKa 8.5 or below form anionic side chains in the cleaning composition and preferably pKa is not more than 8. Generally it is at least 4 and is preferably from 4 to 7.

The side chains can be for instance carboxylate, sulfate or sulfonate and the polymer can be provided to the composition in the acid or the salt form provided that the salt form is present in the composition.

We believe that the inclusion of polymers having anionic side chains and/or side chains which are anionic when in the cleaning composition itself, are beneficial over use of neutral polymers, at least in part due to the greater ability of anionic polymers to form a network which inhibits dissolution of the surfactant. Benefits also exist over cationic polymers, we believe because the majority of surfactants used in dishwashing cleaning compositions are anionic and the use of anionic polymers prevents excessive complexation between the surfactant and the polymer which might lead to failure to release all of the desired surfactant.

The anionic side chains are preferably carboxylate groups and we find that a particularly preferred class of materials having carboxylate side chains is polysaccharides and polysaccharide derivatives. These give particularly good controlled release results.

Preferred polymers also comprise hydroxyl groups or other groups capable of exhibiting hydrogen bonding, as we believe this contributes to the control of release.

Preferably the polysaccharide or polysaccharide derivative has a molecular weight of 1×10⁵ to 9×10⁷, preferably 5×10⁵ to 5×10⁶.

In another preferred embodiment of the invention, the polysaccharide or polysaccharide derivative is selected from the group consisting of xanthan gum, cellulose, modified celluloses, guar gum and gum arabic and mixtures thereof. Preferably the polysaccharide or polysaccharide derivative is selected from the group consisting of xanthan gum and guar gum. Most preferred is xanthan gum, preferably with a molecular weight of approximately 10⁶. Derivatives of xanthan gum can be used provided they retain the anionic side chains and, preferably, hydroxyl groups.

In another preferred embodiment of the invention, the water-soluble polymer is a polyvinyl alcohol (PVA). The anionic charge is then formed in the composition by deprotonation of the hydroxyl groups, converting them to alkoxide groups having a pKa of between 8 and 14. The PVA preferably has a molecular weight of between 10,000 and 60,000 daltons, and is preferably partially hydrolysed to improve its dispersibility in the cleaning composition. The degree of hydrolysis is preferably 85% to 90%. In the partially hydrolysed form, PVA has both anionic and hydrophobic characteristics that are surfactant-like, resulting in excellent sudsing characteristics. As such, they act as a suds booster and aid in initial sudsing (which is explained further).

Other preferred polymers that form anionic side chains when in the cleaning composition itself, are polyacrylic acids and polyvinyl pyrrolidone.

The water-soluble thickening polymer may be intimately combined with the surfactant or alternatively may be located in a separate location on the substrate.

Water-Transfer Agent

The cleaning composition applied to the substrate also comprises a structurant, which is a water-transfer agent capable of withdrawing water from the surfactant. We believe that such a structurant assists in achieving the benefits of the invention in several ways. First, the water-transfer agent can remove water from the surfactant bulk phase and thereby structure the surfactant system. In particular it is preferred that the water transfer agent induces the surfactant to take up the lamellar insoluble form. Secondly, the water-transfer agent can promote bonding between the surfactant and the water-soluble thickening polymer. Thirdly, the water-transfer agent may also increase the viscosity and yield value of the surfactant-containing composition, limiting water ingress to the surfactant-containing composition bulk layer.

In particular, we find a synergistic interaction arises between the water-soluble thickening polymer and the water-transfer agent. We believe the water transfer agent acts as a conduit for the evaporation of water from the composition and can increase the rate of water loss from the composition.

By “capable of withdrawing water from the surfactant” it is meant that there is a greater affinity between water and the water-transfer agent than there is between water and the surfactant.

In a preferred embodiment of the invention the water-transfer agent is selected from the group consisting of inorganic oxides and salts, especially hydratable oxides and salts, in particular oxides and salts of silicon, aluminium, zinc, boron, phosphorus, alkaline earth metals and alkali metals and mixtures thereof. Examples include silicates, silicic acid and silica, citric acid, citrates, sodium and potassium tripolyphosphates, sodium and potassium sulfates, magnesium and calcium sulfates. Preferably, the water-transfer agent is selected from the group consisting of silica, salts of magnesium and mixtures thereof.

More preferably the water-transfer agent is silica, preferably amorphous fumed silica. Hydrophobic silica does not act as water transfer agent as it does not possess the necessary hydrophilicity.

Preferably the water transfer agent has surface area measured by BET (described in DIN 66131 and as originally described in JACS, Vol. 60, 1938, p309 by Brunauer, Emmet and Teller) of from 5 to 800 m²/g. More preferably the water-transfer agent has a surface area of from 100 to 400 m²/g.

In an alternative preferred embodiment, the silica has an average particle size of from 0.05 to 1 μm, preferably from 0.2 to 0.3 μm.

Preferably the composition applied to the substrate comprises from 2.5 to 15% water-transfer agent, more preferably 5 to 10% and most preferably about 6%.

Water-Insoluble Substrate

Preferably the substrate comprises at least two layers, at least one first layer and at least one second layer (preferably a batting layer). The layers herein have an interior and exterior surface (sides of the layers). In both cases, the interior surfaces of the layers are those which face the inside or innermost portion of the wipe of the present invention whereas the exterior surfaces of the layers are those which face the outside or outermost portion of the article. Indeed, the two interior sides or surfaces of said first and said second layer face each other and are positioned adjacent to each other. However, as described herein below one or more additional layers may be present between said first and said second layer. These additional layers, when present, are sandwiched between said first and said second layer.

Preferably, the substrate layers are of different textures with the first layer being softer than the second layer. The substrate may additionally comprise an abrasive layer on one of the outside surfaces of the wipe.

Generally, the orientation of the wipes of the present invention may be defined such that said first layer is closer to the side of the article suitable for gripping (i.e., the gripping side) while the second layer having an abrasive layer on its outside surface is closer to the side of the article to be contacted with the surface to be cleaned (i.e., the dish contact side). Both sides of the article, however, are suitable for contact with the dishware.

The design described above of the water insoluble substrate is believed to enhance the cleaning performance of the wipes herein. The substrate has differing textures on each layer or side such that the gripping side of the article is a different texture from the dish contact side. The substrate may act as an efficient abrasive or even scouring implement. By physically contacting with the dishware the second layer having an abrasive coating, the substrate significantly aids in cleaning and removal of dirt and soil such as grease, burnt-on food residues and other debris. Furthermore, the preferably softer, first layer is suitable for wiping surfaces and/or provides a soft touch for the user of the wipes herein.

Additionally, the first layer and the second layer, as well as additional layers, when present, are preferably bonded to one another in order to maintain the integrity of the article. The layers are preferably heat spot bonded together more preferably using heat generated by ultrasonic sound waves. The bonding may be arranged such that geometric shapes and patterns, e.g. diamonds, circles, squares, etc., are created on the exterior surfaces of the layers and the resulting article.

First Layer

The water insoluble substrate used in the present invention preferably comprises at least one first layer, wherein said first layer is a partially hydrophobic nonwoven. By “partially hydrophobic” it is meant herein that the nonwoven at least partially comprises hydrophobic material. Preferably, the nonwoven of the first layer comprises at least about 40%, more preferably at least about 50%, even more preferably from about 55% to about 75% of hydrophobic material.

Hydrophobic materials are generally based on synthetic organic polymers. Suitable hydrophobic materials herein are selected from the group consisting of synthetic organic polymers such as, acrylic fibers, modacrylic fibers, polyamide fibers, polyester fibers, polyolefin fibers, polyethylene foam, polyurethane foam, and combinations thereof.

Materials suitable for the first layer are selected from the group consisting of cellulosic nonwovens, non-lofty nonwovens, and absorbent nonwovens and combinations thereof. Preferably, the first layer is a non-lofty nonwoven. As used herein, “nonwoven” means that the layer does not comprise fibers, which are woven into a fabric. The fibers present in the nonwoven can either be random (i.e., randomly aligned) or they can be carded (i.e., combed to be oriented in primarily one direction).

The first layer may comprise a variety of both natural and synthetic fibers or materials. As used herein, “natural” means that the materials are derived from plants, animals, insects or byproducts of plants, animals, and insects. The conventional base starting material is usually a fibrous web comprising any of the common synthetic or natural textile-length fibers, or combinations thereof.

Suitable natural materials useful in the present invention include, but are not limited to, silk fibers, keratin fibers and cellulosic fibers. Suitable keratin fibers include those selected from the group consisting of wool fibers, camel hair fibers, and the like. Suitable cellulosic fibers include those selected from the group consisting of wood pulp fibers, cotton fibers, hemp fibers, jute fibers, flax fibers, and combinations thereof. Cellulosic fiber materials are preferred in the present invention.

Suitable synthetic materials useful in the present invention include those selected from the group consisting of acetate fibers, acrylic fibers, cellulose ester fibers, modacrylic fibers, polyamide fibers, polyester fibers, polyolefin fibers, polyvinyl alcohol fibers, rayon fibers, polyethylene foam, polyurethane foam, and combinations thereof.

Nonwovens made from natural materials consist of webs or sheets most commonly formed on a fine wire screen from a liquid suspension of the fibers. See C. A. Hampel et al., The Encyclopedia of Chemistry, third edition, 1973, pp. 793-795 (1973); The Encyclopedia Americana, vol. 21, pp. 376-383 (1984); and G. A. Smook, Handbook of Pulp and Paper Technologies, Technical Association for the Pulp and Paper Industry (1986); which are incorporated by reference herein in their entirety.

Natural material nonwovens useful in the present invention may be obtained from a wide variety of commercial sources.

Methods of making nonwovens are well known in the art. Generally, these nonwovens can be made by air-laying, water-laying, meltblowing, co-forming, spunbonding, or carding processes in which the fibers or filaments are first cut to desired lengths from long strands, passed into a water or air stream, and then deposited onto a screen through which the fiber-laden air or water is passed. The resulting layer, regardless of its method of production or composition, is then subjected to at least one of several types of bonding operations to anchor the individual fibers together to form a self-sustaining web. In the present invention the nonwoven layer can be prepared by a variety of processes including, but not limited to, air-entanglement, hydroentanglement, thermal bonding, and combinations of these processes.

Nonwovens made from synthetic materials useful in the present invention can be obtained from a wide variety of commercial sources

The substrate preferably has a weight of from about 20 gm⁻² to about 200 gm⁻². More preferably, the substrate has a weight of at least about 20 gm⁻² and more preferably less than about 150 gm⁻², more preferably the base weight is in the range of about 20 gm⁻² to about 120 gm⁻², and most preferably from about 30 gm⁻² to about 110 gm⁻². The substrate may have any caliper. Typically, when the substrate is made by hydroentangling, the average substrate caliper is less than about 1.2 mm at a pressure of about 0.1 pounds per square inch. More preferably the average caliper of the substrate is from about 0.1 mm to about 1.0 mm at a pressure of about 0.1 pounds per square inch (about 0.007 kilograms per square meter). The substrate caliper is measured according to standard EDANA nonwoven industry methodology, reference method #30.4-89.

In a preferred embodiment according to the present invention said first layer is a carded, spunlaced partially hydrophobic nonwoven.

In another preferred embodiment according to the present invention said partially hydrophobic nonwoven of said first layer consists of at least about 40%, preferably of from about 50% to about 75%, more preferably of from about 55% to about 65% of synthetic fibres.

In yet another preferred embodiment according to the present invention said partially hydrophobic nonwoven of said first layer comprises polypropylene and rayon fibres.

Second Layer

The water insoluble substrate of the present invention further preferably comprises at least one second layer, wherein said second layer is a low density nonwoven. Preferably, said second layer is a batting layer. By ‘batting layer’ it is meant herein a nonwoven structure of high loft, resiliency and low density.

By ‘low density’ or lofty nonwoven it is meant herein that the layer has a density of from about 0.00005 g/cm³ to about 0.1 g/cm³, preferably from about 0.001 g/cm³ to about 0.09 g/cm³ and a thickness of from about 0.04 inches to about 2 inches at 5 gms/in².

In a preferred embodiment according to the present invention said second layer has a loft of at least about 1 mm, preferably of from about 2 mm to about 4 mm.

In another preferred embodiment according to the present invention said second layer has a density of from about 0.00005 g/cm³ to about 0.1 g/cm³, preferably from about 0.001 g/cm³ to about 0.09 g/cm³.

Materials suitable for the second layer are selected from the group consisting of cellulosic nonwovens, lofty nonwovens, and absorbent nonwovens and combinations thereof. Preferably, the first layer is a lofty nonwoven.

The second layer may comprise a variety of both natural and synthetic fibers or materials. As used herein, “natural” means that the materials are derived from plants, animals, insects or byproducts of plants, animals, and insects. The conventional base starting material is usually a fibrous web comprising any of the common synthetic or natural textile-length fibers, or combinations thereof.

Low density nonwoven made from synthetic materials useful in the present invention can be obtained from a wide variety of commercial sources.

In a preferred embodiment according to the present invention said low-density nonwoven consists of polyethylene terephthalate (PET), and bicomponent sheath core fibers made from polyethylene (PE) and polyethylene terephthalate (PET).

In a preferred embodiment according to the present invention said second layer is made of a high loft, low density nonwoven preferably carded through air bonded structure.

In a particularly preferred embodiment the substrate comprises two second layers which are both batting layers.

Additional Layers

Optionally, the substrate herein may comprise one or more optional layers located between said first layer and said second layer. In a preferred embodiment according to the present invention, the water insoluble substrate herein additionally comprises a third substantially water-impermeable layer located in-between said first layer and said second layer. By ‘substantially water-impermeable’it is meant herein that the layer has a low but not significant level of permeability for water. Preferably, said third substantially water-impermeable layer is a plastic film more preferably a plastic film made from linear low density polyethylene (LLDPE) or metallocene catalyzed low density polyethylene. Preferably, said plastic film has a thickness in the range 0.02 to 0.07 mm.

According to a further aspect of the invention, there is provided a wipe comprising a water-insoluble substrate having applied thereto a cleaning composition comprising:

(a) a surfactant, and

(b) a water-transfer agent capable of withdrawing water from the surfactant with the proviso that the substrate is not a water-insoluble substrate comprising:

(1) a first layer, wherein said first layer is a partially hydrophobic nonwoven; and

(2) a second layer, wherein said second layer is a low density nonwoven and wherein said second layer is adjacent to said first layer and has melded onto the side facing away from said first layer an abrasive coating of thermoplastic material nubs or hooks.

Form and Application of Cleaning Composition

The composition applied to the substrate may be equally distributed over the full surface of the substrate or applied onto a part of the surface. Preferably the composition is applied onto parts of the substrate. More preferably the composition is applied in a stripe pattern. Preferably the stripe pattern has at least one stripe, preferably from 1 to 6 stripes, more preferably 3 to 6 stripes and even more preferably about 5 stripes. Preferably the stripes extend over the full length of the wipe. The stripe or stripes preferably have a width of~at least 3 mm, and preferably have a width of 5 mm to 15 mm.

By controlling the heat and pressure applied to the wipe during application of stripes of cleaning composition the composition can be kept in stripe form or caused to merge in to a single continuous film.

The surface area of the composition on the wipe can be used to modify the rate of surfactant release when the wipe is used. In general, fewer, thinner stripes lead to slower release of the surfactant from the wipe. This is believed to be as a result of reduction of the surface area of the composition which is exposed to water during use.

In a preferred embodiment herein, the aqueous composition (and hence the cleaning composition in the final product) herein covers at least about 30% of the surface of at least one of the layers herein, preferably of said second layer, and preferably covers from about 70% to about 95% of the surface of at least one of the layers herein, preferably of said second layer. This is particularly preferred when the composition is applied as a single layer. Preferably the composition does not extend to the edges of the substrate. Thus preferably at least 2%, more preferably at least 5% of the substrate area, at the edges of the substrate, does not have cleaning composition applied. This contributes to control of release of the surfactant.

Preferably also the composition is concentrated away from the central areas of the substrate. This also maximises control of release as the composition is concentrated away from the areas where the consumer exerts most pressure on the wipe in use.

The components making up the composition applied to the substrate may be premixed and the resulting premixed composition applied to the substrate. Alternatively, the components may be applied to the substrate separately as one or more composition components. By “composition applied to the substrate” is meant the total material that is applied to the water-insoluble substrate, in one or more composition components.

In particular, in some embodiments the concentrated surfactant paste applied to the substrate also comprises the water-soluble thickening polymer. In other preferred embodiments it also comprises the water-transfer agent. Preferably it comprises both water-soluble thickening polymer and water-transfer agent.

However, the invention can also give good results when a first composition component comprising surfactant is applied to the substrate and a second composition component containing water-soluble thickening polymer is applied discretely to the substrate. If desired a third composition component comprising water-transfer agent can be applied discretely but preferably water-transfer agent is included in the same composition component as the surfactant.

Generally the cleaning composition applied to the substrate, and any composition component which forms the composition applied to the substrate, are provided as aqueous compositions which are applied to the substrate and are allowed to dry. Such aqueous compositions preferably have water content of from 5 to 60 wt %, based on total aqueous composition, preferably 10 to 50 wt %, more preferably 15 to 45 wt %.

Preferred aqueous surfactant-containing compositions for application to the substrate contain from 2 to 85 wt % water, preferably from 4 to 81 wt %, more preferably from 16 to 61 wt %. Preferred amounts of water soluble thickening polymer in a surfactant-containing composition are from 1 to 10%, preferably 1.5 to 8 wt %, more preferably from 3 to 7 wt %. Preferred amounts of water transfer agent/structurant in an aqueous surfactant-containing composition are from 1 to 10 wt %, preferably from 1.5 to 8 wt %, more preferably from 2.75 to 7 wt %. Preferred levels of anionic surfactant are from 5 to 75 wt %, preferably 10 to 70 wt %, more preferably 25 to 60 wt %. Preferred levels of amphoteric surfactant are from 2 to 15 wt %, preferably 2.7 to 13.4 wt %, more preferably 2.7 to 13.4 wt %, most preferably 5.4 to 11.8 wt %. Preferred levels of non-ionic surfactant are from 0.1 to 10 wt %, preferably 0.4 to 5 wt %, more preferably 1.5 to 4.5 wt %.

Preferably an aqueous surfactant-containing composition also comprises additional components for improvement of cleaning and sudsing performance at amounts of from 0.25 to 2 wt %, preferably 0.6 to 1.5 wt %.

Particularly preferred components for a surfactant paste (or other aqueous surfactant-containing composition for application to the substrate), and their preferred amounts are as follows. A preferred surfactant paste contains all of the listed components.

| Component | Preferred | More preferred |
|---|---|---|
| Anionic surfactant | 12.3 to 61% | 25 to 54% |
| Amine Oxide | 2.7 to 13.4% | 5.4 to 11.8% |
| Non-ionic surfactant | 0.9 to 4.8% | 1.9 to 4.2% |
| 1,3-cyclohexane bis (methylamine) | 0.2 to 1.2% | 0.45 to 1% |
| Polydimethyl aminoethyl methacrylate | 0.08 to 0.4% | 0.15 to 0.35% |
| Fumed Silica | 1.4 to 7% | 2.75 to 8% |
| Xanthan gum | 1.5 to 7.5% | 3 to 7% |
| Water | 4 to 81% | 16 to 61% |

As can be seen from the discussion above, the water-soluble thickening polymer can be contained in the same composition component as the surfactant. However, it is also possible to provide an aqueous composition comprising surfactant, often in the form of a surfactant paste, which is applied to the substrate and dried to form the first composition component and to provide a second aqueous composition comprising water-soluble thickening polymer, and optionally other ingredients. In such an aqueous composition the level of water soluble thickening polymer can be for instance from 0.5 to 12 wt %, based on aqueous composition, preferably 1 to 10 wt %, more preferably 3 to 8 wt %.

The water-insoluble substrate may comprise more than one layer. The wipes of the present invention may be manufactured by applying the composition to the water-insoluble substrate via a conventional method which may include, but is not limited to, sprinkling, dip coating, spraying, slot coating, and roll transfer (e.g. pressure roll or kiss roll). The remaining layer or layers, when present, may preferably be placed over the surfactant-containing composition. In a wipe in which the water-insoluble substrate comprises more than layer, the layers are preferably sealed together by heat spot sealing. An abrasive coating may be applied onto a layer by screen printing a thermoplastic material (preferably a hot melt adhesive) or by application of a polymeric scrim. The wipes can then be partitioned into units for the consumer's use. Optional manufacturing steps may include calendaring to flatten the wipe, drying, and creping,

Preferably the cleaning composition comprises perfume. The use of the water soluble thickening polymer and the water transfer agent is found to stabilise the perfume and in this case the cleaning composition can be applied by a method of hot melt addition.

The total level of cleaning composition (total of all composition components if separate components are used) on the substrate after application and drying is preferably in the range of from 0.05 to 2 g/cm², preferably 0.01 to 1 g/cm², more preferably 0.02 to 0.08 g/cm².

Wipe

Preferably the wipe of the present invention is substantially dry to the touch before use.

By “dry-to-the-touch” it is meant that the wipes are free of water or other solvents in an amount that would make them feel damp or wet to the touch, such as the touch of a wet wipe or pre-moistened wipe, wherein a substrate is impregnated (ie. soaked) in a liquid and generally low viscosity composition. Thus the wipes of the invention are preferably not of the wet or pre-moistened type.

Preferably the wipe falls within 4 and 5 on the scale when the following moisture test is applied: A dry sheet of disposable Bounty (tradename) Kitchen Towel is placed over the wipe such that the entire wipe is covered by one layer of Bounty Kitchen Towel. A 3 cm by 3 cm 50 gram weight is placed on top on the wipe and Bounty sheet. The weight is left for 1 minute and then removed. The amount of moisture transferred from the wipe to the sheet of Bounty during the above test method is a measure of the wetness of the wipe. The Bounty sheet is visually graded according to the below scale for the presence of a moisture mark, perceived as a visual difference in appearance of the Bounty sheet when held up to a light source. The scale is based on the percentage coverage of a moisture mark over the 3 cm by 3 cm area of the Bounty sheet which was covered by the weight (weight area).

| Scale | % coverage of the weight area |
|---|---|
| 1 | greater than 80% |
| 2 | 75-80% |
| 3 | 40-75% |
| 4 | less than 10% |
| 5 | less than 5% |

Preferably also the wipes are substantially dry. That is they exhibit a moisture retention of less than about 12 mg/cm², preferably less than about 6 mg/cm², more preferably less than about 2 mg/cm^{2 .} The moisture retention is indicative of the dry feel that users perceive upon touching the wipes of the invention as opposed to the feel of “wet” wipes.

In order to determine the Moisture Retention of the present wipes, the following

| | |
|---|---|
| Bounty ® White | Procter & Gamble |
| Paper Towel | SKU 37000 63037 |
| | Basis Weight = 42.14 gsm |
| | (grams per square meter) |
| Balance | Accurate to 0.0 g |
| Lexan ® | 0.5″ thickness |
| (hard, transparent | large enough to cover |
| polycarbonate | samples completely |
| polymer block) | and weighs 1000 g |
| Weight | A 2000 grams weight |
| | or combination to |
| | equal 2000 grams |

Next, weigh two paper towels separately and record each weight. Place one paper towel on flat surface (e.g. lab bench). Place the sample wipe on top of that towel. Place the other paper towel on top of sample wipe. Next, place the Lexan® and then the 2000 grams weight(s) on top of the sandwiched sample wipe. Wait 1 minute. After the minute, remove weight(s) and Lexan®. Weigh the top and bottom paper towel and record the weight.

Calculate the Moisture Retention by subtracting the initial paper towel weight from the final weight (after 1 minute) for both the top and bottom paper towels. Add the weight differences obtained for the top and bottom paper towels. Assuming multiple sample wipes are tested, average the total weight differences to obtain the Moisture Retention.

The wipes according to the present invention are generally in sheet form. They may have a length of from about 10 to about 20 cm, a width of from about 10 to about 20 cm and a thickness of from about 2 to about 5 mm.

The wipe of the present invention is preferably “disposable”. By “disposable” herein it is meant that, once exhausted of surfactant, the wipe is thrown away. It is not intended that any additional cleaning composition is applied to the wipe by the consumer to replace the surfactant-containing composition released from the wipe during its use. Preferably the wipe will be used by the consumer for at least two uses before the wipe is disposed of. As an example, a single use in a hand dishcare application is the cleaning by hand dishwashing of a single load of dishes, for instance accumulated during one day in a four person family household.

An advantage of the invention is the improved “mileage” obtainable. That is, the invention allows controlled release of surfactant and thus effective sudsing and/or effective cleaning over a longer period, and in particular over a greater number of items cleaned, than the prior art.

Mileage can be defined as the number of 24 cm diameter plates effectively cleaned of 5 g soil by 1 wipe (using the protocol below). Preferably the wipes of the invention give mileage of at least 16, preferably at least 18, more preferably at least 20 and in preferred cases at least 22 plates cleaned per wipe. In particularly preferred embodiments mileage can be at least 25, preferably at least 30 and in some cases at least 35 plates.

Mileage can also be determined in terms of sudsing grade. In particular, the wipes of the invention exhibit a sudsing grade at least 3 (on the scale discussed below) after cleaning at least 12, preferably at least 15, more preferably at least 20 plates (using the protocol described below). In particularly preferred embodiments the sudsing grade can be at least 3 after cleaning at least 25, preferably at least 30 plates.

The benefits of aspects of the invention requiring use of the water-soluble thickening polymer can be illustrated by improvement in mileage by the inclusion of the water-soluble thickening polymer. Thus, if a wipe of an aspect of the invention requiring water-soluble thickening polymer is compared with a wipe identical except that the water-soluble thickening polymer is omitted, the increase in mileage can be defined. Increase in mileage can be defined either as increased number of plates effectively cleaned or as increased number of plates at which sudsing grade is 3 or greater. With this comparison the improvement is preferably at least 2, more preferably at least 5, and in some cases at least 8 plates.

The moisture content of the wipe affects the generation of initial suds, as well as the mileage of the wipe. Initial suds is an important consumer signal that foam is being generated. It is believed that, water displaces some of the intramolecular H-bonding interactions between polymer chains, leading to a more porous structure. This allows surfactant to leak out and dissolve during washing, resulting in a higher level of foam encountered earlier in the wash. However, this can lead to faster depletion of the surfactant, thereby lowering the mileage. Therefore, the moisture content of the wipe must be balanced with polymer level and type, in order to obtain optimum effect of high initial suds and long mileage.

Preferably, the wipe of the invention is such that the cleaning composition has a level of free water not more than 15%, preferably not more than 10%. Free water can be measured as the percentage water, by weight of the total composition, which can be readily lost by azeotropic distillation.

The number of washes for which the wipe releases a suitable quantity of surfactant will depend, among other factors, on the amount of pressure applied by the user to the wipe. Typically, it would be expected that the wipe be used at a pressure of from 50 to 6000 Pa, particularly from 160 to 4500 Pa.

The wipes of all aspects of the present invention can be used for cleaning soiled surfaces by wetting the wipe or the surface and applying the wipe to the surface to remove soils. They are particularly suitable for hand dishcare applications to clean “dishware” including dishes, cups, cutlery, glassware, food storage containers, cooking utensils, cookware and the like. They may also be useful in cleaning household hard surfaces, in particular hard surfaces and in kitchens such as sinks, worktops, fixtures and appliances etc.

According to a further aspect of the invention there is provided a method of dishcare comprising the steps of:

providing a disposable wipe comprising a water-insoluble substrate having applied thereto a composition comprising:

(a) surfactant, and

(b) a water-soluble thickening polymer having anionic side chains and/or side chains which are anionic when in the cleaning composition itself, wetting said wipe with water, and

applying the wetted wipe to soiled dishware in order to remove soils.

According to a still further aspect of the invention there is provided a method of dishcare comprising the steps of:

providing a disposable wipe comprising a water-insoluble substrate having applied thereto a composition comprising:

(a) a surfactant, and

(b) a water-soluble thickening polymer having anionic side chains and/or side chains which are anionic when in the cleaning composition itself,

providing soiled dishware,

wetting said soiled dishware and

applying the wipe to the wetted soiled dishware in order to remove soil.

According to a yet further aspect of the invention there is provided a method of cleaning soiled dishware comprising the steps of:

providing a disposable wipe comprising a water-insoluble substrate having applied thereto a cleaning composition comprising:

(a) a surfactant, and

(b) 2.5 to 10% wt of a water soluble thickening polymer having anionic side chains and/or side chains which are anionic when in the cleaning composition itself,

wetting said wipe with water, and

applying the wetted wipe to soiled dishware in order to remove soils.

According to a further aspect of the invention there is provided a method of cleaning soiled dishware comprising the steps of:

providing a disposable wipe comprising a water-insoluble substrate having applied thereto a cleaning composition comprising:

(a) a surfactant, and

(b) 2.5 to 10% wt of a water-soluble thickening polymer having anionic side chains and/or side chains which are anionic when in the cleaning composition itself,

wetting said soiled dishware and

applying the wipe to the wetted soiled dishware in order to remove soils.

Dishwashing Sponges

The cleaning compositions of the invention can also advantageously be applied to dishwashing sponges and in a further aspect of the invention we provide a dishwashing sponge having impregnated therein a cleaning composition comprising:

(a) a surfactant,

(b) a water-soluble thickening polymer having anionic side chains and/or side chains which are anionic when in the cleaning composition itself, and

(c) a water-transfer agent capable of withdrawing water from the surfactant.

Alternatively the composition can comprise (a) a surfactant, and (b) at least 3%, by weight of the cleaning composition, xanthan gum or a derivative thereof.

Alternatively the composition can comprise (a) a surfactant, (b) from 5 to 9%, by weight of the cleaning composition, water-soluble thickening polymer having anionic side chains and/or side chains which are anionic when in the cleaning composition itself.

Alternatively the composition can comprise (a) a surfactant, and (b) a water-transfer agent capable of withdrawing water from the surfactant.

In these aspects preferred features of the composition discussed above may be used as applicable.

The sponge can also have an abrasive layer. The sponge can be formed from, for instance, natural cellulose or synthetic material.

Optional Additional Ingredients

The cleaning composition used in the wipe according to the invention may comprise any other suitable components known for use in dishcare or hard surface cleaning.

The composition may also contain diamines, polymeric suds stabilisers, film-forming polymers, colorants, perfume and perfume delivery agents, stabilizers, solvents, density control agents, drying agents, hydrotropes, salt, solidification agents, preservation agents, water spotting/filming/drying control agents, and mixtures thereof.

### EXAMPLE 1

A surfactant-containing composition component is provided to a substrate (method of production of substrate discussed below) by application of a surfactant paste composition as follows:

48% alkyl ethoxy sulfate having average 0.6EO groups per molecule

5.4% Neodol 91-8 nonionic surfactant

10.8% amine oxide amphoteric surfactant

0.9% 1,3-cyclohexane bis(methylamine)

0.4% polydimethyl aminoethyl acrylate

balance water.

7.5 g of this composition is applied to a 5-layer water insoluble substrate as a series of stripes. The substrate comprised a polymeric scrim layer, two batting layers, a polymeric membrane layer and a nonwoven topsheet layer (arranged in that order). The composition was positioned between one of the batting layers and the polymeric membrane layer (details given below). These were control wipes A.

Wipes B of the invention were produced by mixing 95 wt % of the cleaning composition with 5 wt % xanthan gum, and applying 7.5 g of this mixture to the substrate in the same manner.

Wipes C of the invention were produced by mixing 95 wt % of the cleaning composition with 7.5 wt % xanthan gum, and applying 7.5 g of this mixture to the substrate in the same manner.

Wipes D of the invention were produced by mixing 88 wt % of the cleaning composition with 5 wt % amorphous fumed silica and 7 wt % xanthan gum, and applying 7.5 g of this mixture to substrate in the same manner.

Moisture content of the wipes was allowed to stabilize to about 5%, either by curing at room temperature for 7 days, or by oven drying at 50 ° C. for 8 hours.

Results showing sudsing grade as the number of plates cleaned increases are given in Table 1 below.

TABLE 1

| Mileage | Sudsing | Sudsing | Sudsing | Sudsing |
|---|---|---|---|---|
| (No. of | grade | grade | grade | grade |
| plates) | Wipe A | Wipe B | Wipe C | Wipe D |
| 1 | 5 | 5 | 3 | 7 |
| 2 | 5 | 7 | 5 | 7 |
| 3 | 5 | 7 | 5 | 7 |
| 4 | 7 | 9 | 5 | 7 |
| 5 | 7 | 9 | 7 | 7 |
| 6 | 7 | 9 | 7 | 7 |
| 7 | 7 | 7 | 7 | 7 |
| 8 | 7 | 7 | 7 | 7 |
| 9 | 7 | 7 | 7 | 9 |
| 10 | 7 | 7 | 7 | 7 |
| 11 | 5 | 7 | 7 | 7 |
| 12 | 5 | 7 | 7 | 5 |
| 13 | 5 | 5 | 7 | 9 |
| 14 | 3 | 5 | 7 | 7 |
| 15 | 3 | 3 | 5 | 7 |
| 16 | 1 | 3 | 5 | 7 |
| 17 | 1 | 1 | 5 | 7 |
| 18 | 1 | 1 | 5 | 7 |
| 19 | 1 | 1 | 5 | 7 |
| 20 | 1 | 1 | 5 | 7 |
| 21 | 0 | 1 | 5 | 7 |
| 22 | | 0 | 3 | 5 |
| 23 | | | 3 | 5 |
| 24 | | | 1 | 5 |
| 25 | | | 1 | 5 |
| 26 | | | 1 | 3 |
| 27 | | | 0 | 3 |
| 27 to 30 | | | | 3 |
| 31 | | | | 5 |
| 32 to 35 | | | | 3 |
| 35 to 39 | | | | 1 |
| 40 | | | | 0 |

These results show that Wipes B and C and particularly D according to the invention exhibit greater sudsing grade for a longer period than Wipe A not according to the invention.

### EXAMPLE 2

A surfactant-containing composition component is provided to a substrate (method of production of substrate discussed below) by application of a surfactant paste composition as follows:

62.3% alkyl ethoxy sulfate having average 0.6EO groups per molecule

4.70% Neodol 91-8 nonionic surfactant

14.11% amine oxide amphoteric surfactant

1.20% 1,3-cyclohexane bis(methylamine)

0.5% polydimethyl aminoethyl acrylate

1% NaOH

0%4% Polymer (polyvinyl alcohol, polyacrylic acid, polyvinyl pyrrrolidone)

Balance H₂O

Wipes E of the invention were produced with 0% polymer with 4.5 g of the above composition added to the water insoluble substrate. These were control wipes.

Wipes F of the invention were produced with 4% polyvinyl alcohol and applying 4.5 g of this mixture to the substrate.

Wipes G of the invention were produced with 4% of polyacrylic acid polymer and applying 4.5 g of this mixture to the substrate.

Wipes H of the invention were produced by mixing 4% of polyvinyl pyrrolidone and applying 4.5 g of this mixture to the substrate.

| Mileage | Sudsing | Sudsing | Sudsing | Sudsing |
|---|---|---|---|---|
| (No. of | grade | grade | grade | grade |
| plates) | Wipe E | Wipe F | Wipe G | Wipe H |
| 1 | 7 | 1 | 1 | 1 |
| 2 | 9 | 1 | 1 | 2 |
| 3 | 9 | 2 | 1 | 3 |
| 4 | 9 | 3 | 1 | 4 |
| 5 | 9 | 3 | 1 | 5 |
| 6 | 9 | 6 | 2 | 7 |
| 7 | 8 | 6 | 2 | 7 |
| 8 | 5 | 7 | 3 | 8 |
| 9 | 4 | 7 | 3 | 8 |
| 10 | 1 | 7 | 3 | 8 |
| 11 | 0 | 8 | 4 | 8 |
| 12 | | 8 | 4 | 7 |
| 13 | | 8 | 4 | 7 |
| 14 | | 7 | 4 | 7 |
| 15 | | 7 | 4 | 5 |
| 16 | | 7 | 6 | 4 |
| 17 | | 5 | 6 | 4 |
| 18 | | 4 | 6 | 3 |
| 19 | | 4 | 5 | 3 |
| 20 | | 4 | 5 | 3 |
| 21 | | 3 | 5 | 3 |
| 22 | | 2 | 4 | 3 |
| 23 | | 2 | 4 | 3 |
| 24 | | 2 | 4 | 2 |
| 25 | | 1 | 4 | 1 |
| 26 | | 1 | 4 | 1 |
| 27 to 33 | | 0 | 3 | 0 |
| 34 to 36 | | | 2 | |
| 36 to 42 | | | 1 | |
| 43 | | | 0 | |

Wipes F, G, and H exhibit sustained sudsing and greater mileage due to the anionic charged form of the polymer contained in the surfactant paste.

Production of Wipes

The surfactant paste is applied to one side of the batting layer of the substrate by extruding it through a coating head continuously in five lines about 12 mm wide separated by a distance of 20 mm, measuring widthwise across the web, making parallel lines on each side of the web.

The second layer that already carries the pastes is continuously fed over the first substrate placing the first layer in contact with the surfactant-containing layer. The webs are continuously fed to an ultrasonic sealer, which seals a tilde shaped dot pattern comprising a grid of 8 mm long sealing points spaced evenly across the web. The web is cut into individual articles measuring about 120 mm×160 mm rectangles with rounded corners, which has a total of about 70 sealing points per article.

Protocol for Determination of Suds Grade

Materials Required:

Wipes

Soil: (see below for description of soil making)

Ceramic Plates (black with diameter˜24 cm)

Plate rack

Gloves

Brush for soiling plates

Balance

Thermometer

Source of running tap water/sink

Timer for setting water flow rate

Test Conditions:

Soil amount per plate: 5 grams(±0.1 gr)

Water Hardness: 7 gpg (grains per US gallon, 1 grain=64.8 mg CaCO3) (US conditions.

Europe conditions 15 gpg)

Water temperature: 33 C (±1 C)

Water Flow: 6 L/min

Soiling Procedure:

Prepare the soil as described below, and mix well in food processor to ensure a uniform consistency.

Put plates on balance and weigh out 5 grams of soil. Using a small brush, spread the soil on each plate until it is evenly distributed (diameter of soil is ˜10 cm).

Place plates in plate rack. Soiled plates must be used within 30 minutes after first plate being soiled. First soiled plates are cleaned first during the test method.

Washing Procedure:

1. Bring running tap water to 33 C flowing at 6 L/min.

2. Place gloves on hands of operator.

3. Pour 20 ml water onto the wipe (evenly spread).

4. Take first plate and pass it (almost vertically) quickly through the water flow (˜1 sec), soiled side towards the water flow. Keep the plate vertical before starting to clean.

5. Soiled plates are cleaned using a circular motion, using the rough side of the wipe, on the front and back of the plate: 10 clockwise circular motions and 10 counter-clockwise on the front, 6 rotations on the back of plate. Keep the wipe between thumb and remaining fingers while washing.

6. Grade the plate based on the suds grading scale.

7. Rinse the plate under the tap water and put aside (even if small amount of soil remains).

8. Rinse the wipe by passing it back and forth 3× through the water flow.

9. Rinse off suds from gloves.

10. Take the next plate out of rack and pass it quickly through the water flow.

11. Repeat the cleaning procedure from steps 4-10. Steps 7 through 10 should be done within 15 seconds.

12. After cleaning each 10 plates, squeeze the wipe once slightly after passing it 3× through the water flow. Pass once again after squeezing. This allows any excess build-up of soil to be removed from the wipe, and also facilitates suds release, which is necessary as the test proceeds. This is relevant to what consumers would need to do to keep washing.

13. As soon as no suds remain on the plate, gloves or the wipe, the endpoint has been reached. To be sure the end-point has been reached, test is finished: press the wipe once between fingers; if only soil passes between fingers, then endpoint has been reached.

Preparation of Soil

1. Pre-Work

1. Put carbonades(beef cubes) in a beaker

2. Place in microwave oven for 2 min (780 Watt)

3. Cut carbonades with a knife into fine pieces

4. Mix carbonades (hand blender)

5. Weigh out 100 gr soil made up of:

| | |
|---|---|
| carbonades | 10 gr |
| instant mashed potato | 5 gr |
| flour | 22 gr |
| fullfat milk | 2 gr |
| dried milk powder (low fat) | 15 gr |
| water | 19 gr |
| olive oil | 2 gr |
| Mazola oil | 2 gr |
| blanc de boeuf (beef fat) | 2 gr |
| margarine | 2 gr |
| butter | 2 gr |
| pork fat | 2 gr |

6. Beat one egg and weigh exactly 15 gr

7. Pour water into the fullfat milk

8. Weigh the whole content of grease (blanc de boeuf, margarine, butter, pork fat) and oils (mazola and olive oil) together in one beaker and put in the microwave for 1 min (780 Watt). Then stir gently with a teaspoon (before adding to the soil mixture) so it's all well mixed.

2. Mixing (Hand Blender): Add All the Ingredients in the Following Order in a Beaker:

1. Pour milk powder into the flour

2. Pour the water+milk into the flour+milk powder

3. Start the mixing

4. Add the exact weight of the mixed carbonades

5. Continue the mixing

6. Add 50% of the instant mashed potato and 50% of the beaten eggs

7. Continue the mixing and add gently the rest of the instant mashed potato and beaten eggs

8. Continue the mixing

9. Pour gently the grease and oils mixture and continue mixing

10. Stop the mixer from time to time and take off solids still hanging on the rim and continue the mixing until the soil is homogeneous (ca 15 minutes).

Suds Grading Scale

0 No Suds

1 Very slight visible particles of suds

2 Slight irregular patches of suds

3 More visible irregular generalized suds over most of plate

4 Some suds with variable thickness over most of plate

5 Moderate even suds over entire plate

6 Slight moderate thick generalized suds over entire plate

7 Moderate thick generalized suds over entire plate

8 Heavy dense irregular generalized suds over entire plate

9 Thick heavy dense irregular suds over entire plate

10 Very thick heavy dense irregular suds over entire plate

Production of a Wipe Comprising Polyvinyl Alcohol, Polyacrylic Acid or Polyvinyl Pyrrolidone as Water-Soluble Thickening Polymer

Both the water-soluble thickening polymer and a surfactant paste (nominally at 35 percent moisture) are heated above the melting point temperature of the polymer, prior to mixing. The mixture of the polymer and the surfactant paste is then dried to 15% moisture or less, using one of several commercially available drying equipment selected from wiped film evaporator, drum dryer, rotary vacuum dryer, continuous tray tunnel, vacuum shelf batch, or other suitable equipment for removal of water in the vapor phase with tight control of the process temperature. Special consideration must be made to avoid significant aeration of the mixture, especially if vacuum drying equipment is utilised. Preferably, the mixture may not be exposed to a temperature greater than 120° C. for more than 5-10 minutes, and a temperature greater than 110° C. for more than 30 minutes, to prevent degradation of the mixture. The resulting dried, hot paste is maintained at 60-80° C. Perfume and colorants may be added via a late product differentiation process including a static mixer very close to application of the paste to the wipe substrate. The completely mixed structured paste is now applied to the substrate by pumping the mixture through a narrow orifice with an opening that produces the desired width and thickness of the paste. Provisions must be made to ensure that the applied paste is cooled quickly below the melting point of the polymer, to prevent that the stickiness of the paste would negatively impact further processing of the wipe.

The disclosure of all patents, patent applications (and any patents which issue thereon, as well as any corresponding published foreign patent applications), and publications mentioned throughout this description are hereby incorporated by reference herein. It is expressly not admitted, however, that any of the documents incorporated by reference herein teach or disclose the present invention.

It should be understood that every maximum numerical limitation given throughout this specification will include every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

While particular embodiments of the subject invention have been described, it will be obvious to those skilled in the art that various changes and modifications of the subject invention can be made without departing from the spirit and scope of the invention. In addition, while the present invention has been described in connection with certain specific embodiments thereof, it is to be understood that this is by way of illustration and not by way of limitation and the scope of the invention is defined by the appended claims which should be construed as broadly as the prior art will permit.

What is claimed is:

1. A wipe comprising a water-insoluble substrate having applied thereto a cleaning composition comprising:
(a) a surfactant;
(b) a water-soluble thickening polymer, said polymer comprising at least one of the following: anionic side chains and side chains which are anionic when in the cleaning composition itself; and
(c) a water-transfer agent capable of withdrawing water from the surfactant.

2. A wipe according to claim 1 in which the water-soluble thickening polymer has anionic side chains.

3. A wipe according to claim 1 in which the side chains are carboxylate side chains.

4. A wipe according to claim 1 in which the water-soluble thickening polymer is a polysaccharide or polysaccharide derivative.

5. A wipe according to claim 4 in which the polysaccharide or polysaccharide derivative has a molecular weight of from about 1×10³ to about 9×10⁷.

6. A wipe according to claim 4 in which the polysaccharide or polysaccharide derivative is selected from the group consisting of xanthan gum and derivatives thereof, cellulose, modified celluloses, guar gum and gum arabic and mixtures thereof.

7. A wipe according to claim 1 wherein the water-soluble thickening polymer is selected from the group consisting of a polyvinyl alcohol, a polyacrylic acid, a polyvinyl pyrrolidone, and mixtures thereof.

8. A wipe according to claim 7 wherein the water-soluble thickening polymer is a polyvinyl alcohol having a molecular weight of between 10,000 and 60,000 daltons, and is partially hydrolyzed.

9. A wipe according to claim 1 in which the water-transfer agent is selected from the group consisting of inorganic oxides and salts.

10. A wipe according to claim 9 in which the water-transfer agent comprises silica.

11. A wipe according to claim 10 in which the silica has a surface area measured by BET of from about 50 to about 800 m²/g.

12. A wipe according to claim 10 in which the silica has an average particle size of from about 0.05 to about 1 μm.

13. A wipe according to claim 1 in which the quantity of the cleaning composition applied to the substrate is from about 0.005 to about 2 g/cm² of water-insoluble substrate.

14. A wipe according to claim 1 in which the cleaning composition comprises from about 2.5 to about 15% water-soluble thickening polymer, by weight of the cleaning composition.

15. A wipe according to claim 1 in which the cleaning composition comprises from about 2.5 to about 15% water-transfer agent, by weight of the cleaning composition.

16. A wipe according to claim 1 in which the cleaning composition is applied to the substrate in one of the following manners: (a) as a single uniform layer which covers from about 70 to about 95% of the area of the substrate; or (b) in a stripe pattern which comprises from 1 to 6 stripes, and each stripe has a width of from about 3 to about 15 mm.

17. A wipe comprising a water-insoluble substrate having applied thereto a cleaning composition comprising:
(a) a surfactant; and
(b) at least about 3%, by weight of the cleaning composition, of xanthan gum or a derivative thereof.

18. A wipe according to claim 17 in which the cleaning composition also comprises a water-transfer agent capable of withdrawing water from the surfactant.

19. A method of cleaning a surface comprising the steps of:
providing a disposable wipe having applied thereto a cleaning composition comprising:
a surfactant;
a water-soluble thickening polymer comprising at least one of the following: anionic side chains and side chains which are anionic when in the cleaning composition itself; and
a water-transfer agent capable of withdrawing water from the surfactant;
wetting said wipe with water; and
applying the wetted wipe to a soiled surface in order to remove soils.

20. A method of cleaning a surface comprising the steps of:
providing a disposable wipe having applied thereto a cleaning composition comprising:
a surfactant,
a water-soluble thickening polymer comprising at least one of the following: anionic side chains and side chains which are anionic when in the cleaning composition itself, and
a water-transfer agent capable of withdrawing water from the surfactant;
wetting a soiled surface and applying the wipe to the wetted soiled surface in order to remove soils.

21. A wipe comprising a water-insoluble substrate having applied thereto a cleaning composition comprising:
(a) a surfactant,
(b) from about 5 to about 9%, by weight of the cleaning composition, water-soluble thickening polymer comprising at least one of the following: anionic side chains and side chains which are anionic when in the cleaning composition itself.

22. A wipe according to claim 21 in which the amount of water-soluble thickening polymer is from about 6 to about 7% by weight of the composition.

23. A wipe according to claim 21 in which the composition also comprises a water-transfer agent capable of withdrawing water from the surfactant.

24. A wipe comprising a water-insoluble substrate having applied thereto a cleaning composition comprising:
(a) a surfactant, and
(b) a water-transfer agent capable of withdrawing water from the surfactant,
wherein said substrate comprises:
(1) a first layer, wherein said first layer is a partially hydrophobic nonwoven; and
(2) a second layer, wherein said second layer is a low density nonwoven and wherein said second layer is adjacent to said first layer and has melded onto the side facing away from said first layer an abrasive coating of thermoplastic material nubs or hooks.

25. A wipe according to claim 24 in which the composition further comprises a water-soluble thickening polymer comprising at least one of the following: anionic side chains and side chains which are anionic when in the cleaning composition itself.

26. A method of caring for dishes comprising the steps of:
providing a disposable wipe comprising a water-insoluble substrate having applied thereto a cleaning composition comprising:
(a) a surfactant, and
a water-soluble thickening polymer comprising at least one of the following: anionic side chains and side chains which are anionic when in the cleaning composition itself, providing soiled dishware and either (1) wetting said wipe with water, and applying the wetted wipe to the soiled dishware in order to remove soils or (2) wetting said soiled dishware and applying the wipe to the wetted soiled dishware in order to remove soils.

27. A method according to claim 26 in which the composition also comprises a water transfer agent capable of withdrawing water from the surfactant.

28. A disposable dishwashing wipe capable of effectively cleaning at least sixteen 24 cm diameter plates of 5 g soil according to the Washing Procedure.

29. A disposable dishwashing wipe capable of exhibiting a suds grade at least 3 on the scale described herein after cleaning at least twleve plates using the protocol for determination of suds grade.

30. A dishwashing sponge having impregnated therein a cleaning composition comprising:
(a) a surfactant,
(b) a water-soluble thickening polymer comprising at least one of the following: anionic side chains and side chains which are anionic when in the cleaning composition itself, and a water-transfer agent capable of withdrawing water from the surfactant.

31. A dishwashing sponge having impregnated therein a cleaning composition comprising:
(a) a surfactant, and
(b) at least 3%, by weight of the cleaning composition, xanthan gum or a derivative thereof.

32. A dishwashing sponge having impregnated therein a cleaning composition comprising
(a) a surfactant, and
(b) from 5 to 9%, by weight of the cleaning composition, water-soluble thickening polymer comprising at least one of the following: anionic side chains and side chains which are anionic when in the cleaning composition itself.

33. A dishwashing sponge having impregnated therein a cleaning composition comprising: (a) a surfactant, and (b) a water-transfer agent capable of withdrawing water from the surfactant.
